(19) United States
(12) Patent Application Publication
(10) Pub. No.: US 2020/0268026 A1
(43) Pub. Date: Aug. 27, 2020

(54) STEVIOL GLYCOSIDE SOLUBILITY ENHANCERS

(71) Applicant: CARGILL, INCORPORATED, Wayzata, MN (US)

(72) Inventors: Anil Bhagwan KHARE, Minnetonka, MN (US); Zheng Yang, Blaine, MN (US)

(73) Assignee: CARGILL, INCORPORATED, Wayzata, MN (US)

(21) Appl. No.: 16/753,712

(22) PCT Filed: Oct. 8, 2018
(86) PCT No.: PCT/US2018/054848

§ 371 Date: Apr. 3, 2020

Related U.S. Application Data
(60) Provisional application No. 62/569,279, filed on Oct. 6, 2017.

(51) Int. Cl. A23L 27/30; A23L 2/60; A23L 2/68; A23L 29/25; A23L 29/212; A23L 27/00

(52) U.S. Cl. CPC A23L 27/36; A23L 2/60; A23L 27/88; A23L 29/25; A23L 29/212; A23L 2/68

(57) ABSTRACT

A solubilized steviol glycoside composition including one or more steviol glycosides and one or more steviol glycoside solubility enhancers can be used as a sweetener composition to sweeten other compositions (sweetenable compositions) such as foods, beverages, medicines, oral hygiene compositions, pharmaceuticals, nutraceuticals, and the like.

### CROSS-REFERENCE TO RELATED APPLICATIONS

This application claims the benefit of U.S. Provisional Application Ser. No. 62/569,279, filed Oct. 6, 2017, and entitled “Steviol Glycoside Solubility Enhancers”, which application is hereby incorporated by reference herein in its entirety.

### FIELD

The present disclosure relates to solubilized steviol glycoside solutions having one or more steviol glycosides and one or more steviol glycoside solubility enhancers and methods of making and using those solutions. The present disclosure also relates to sweetener compositions and throw syrups to prepare sweetened compositions including food, beverages, dental products, pharmaceuticals, nutraceuticals, and the like.

### BACKGROUND

Sugars, such as sucrose, fructose and glucose, are utilized to provide a pleasant taste to beverages, foods, pharmaceuticals, and oral hygienic/cosmetic products. Sucrose, in particular, imparts a taste preferred by consumers. Although sucrose provides superior sweetness characteristics, it is caloric. Non-caloric or lower caloric sweeteners have been introduced to satisfy consumer demand, and there is desire for these types of sweeteners that have favorable taste characteristics.

Stevia is a genus of about 240 species of herbs and shrubs in the sunflower family (Asteraceae), native to subtropical and tropical regions from western North America to South America. The species Stevia rebaudiana, commonly known as sweetleaf, sweet leaf, sugarleaf, or simply stevia, is widely grown for its sweet leaves. Stevia-based sweeteners may be obtained by extracting one or more sweet compounds from the leaves. Many of these compounds are steviol glycosides, which are glycosides of steviol, a diterpene compound. These diterpene glycosides are about 150 to 450 times sweeter than sugar.

Examples of steviol glycosides are described in WO 2013/096420 (see, e.g., listing in FIG. 1); and in Ohta et. al., “Characterization of Novel Steviol Glycosides from Leaves of Stevia rebaudiana Morita,” J. Appl. Glycosi., 57, 199-209 (2010) (See, e.g., Table 4 at p. 204). Structurally, the diterpene glycosides are characterized by a single base, steviol, and differ by the presence of carbohydrate residues at positions C13 and C19, as presented in FIGS. 2a-2k. See also PCT Patent Publication WO 20013/096420.

Typically, on a dry weight basis, the four major steviol glycosides found in the leaves of Stevia are dulcoside A (0.3%), rebaudioside C (0.6-1.0%), rebaudioside A (3.8%) and stevioside (9.1%). Other glycosides identified in Stevia extract include one or more of rebaudioside B, D, E, F, G, H, I, J, K, L, M, N, O, steviolbioside and rubusoside.

While the major steviol glycoside Reb A is commonly used as sweetener in beverage applications, it has off-taste issues. More recently, there has been focus on certain minor steviol glycosides which have better taste properties. For example, rebaudioside M has higher sweetness intensity and is more potent than other steviol glycosides (e.g., see Prakash, I., et al. (2013) Nat. Prod. Commun., 8: 1523-1526, and WO 2013/096420). Rebaudioside D tastes about 200-220 times sweeter than sucrose and in a sensory evaluation it had a slow onset of sweetness and was very clean (e.g., see Prakash, I., et al. (2012) Int. J. Mol. Sci., 13:15126-15136).

Rebaudiosides can be challenging to use because they have less than desirable water solubility properties. For example, it has been reported that Reb D is difficult to use in food products because of its low solubility in water at room temperature. For instance, Reb D needs to be heated to near boiling water temperature for 2 hours in order to achieve complete dissolution at 0.8% concentration. At most only 300 to 450 ppm can be solubilized in water at 23° C. (e.g., see US 2013/0251881). As another example, rebaudioside M obtained from Stevia rebaudiana has poor aqueous solubility and dissolution qualities in beverage formulations (e.g., see US 2014/0171519).

Certain methods to improve rebaudioside solubility are less than desirable because they are labor intensive, requiring high processing temperatures. For example, see WO 2013148177.

### SUMMARY

The present disclosure generally relates to solubilized steviol glycoside compositions, e.g., aqueous solutions, having one or more steviol glycosides and one or more steviol glycoside solubility enhancers. The disclosure also relates to uses of the solubilized steviol glycoside compositions as sweetener compositions, which may be used to prepare sweetened compositions including food, beverages, dental products, pharmaceuticals, nutraceuticals, and the like.

One aspect provides an aqueous steviol glycoside solution comprising greater than 0.2% (wt) of a total steviol glycoside composition comprising one or more steviol glycosides, wherein if the steviol glycoside composition includes rebaudioside A, rebaudioside D, or rebaudioside M, the rebaudioside A individual concentration is at least 1% (wt), the rebaudioside D individual concentration is at least 0.2% (wt), or the rebaudioside M individual concentration is at least 0.3% (wt) and a solubility enhancer in an amount effective to enhance the solubility of at least one of the steviol glycosides.

In some aspects, the solubility enhancer comprises gallic acid. In some aspects, the amount of solubility enhancer effective to enhance solubility comprises an amount such that the total steviol glycoside remains in solution for at least three days when stored at a temperature of about 20° C. to about 30° C., or about 23° C. to about 28° C. In some aspects, the solubility enhancer is present at a molar ratio of steviol glycoside to solubility enhancer of between 1:0.5 to 1:7.

In some aspects, the total steviol glycoside composition comprises rebaudioside A. In some aspects, the total steviol glycoside composition comprises rebaudioside D. In some aspects, the total steviol glycoside composition comprises rebaudioside M.

In some aspects, the aqueous steviol glycoside solution further comprises corn starch fiber. In some aspects, the corn starch fiber is present at 0.05% (wt) to 0.5% (wt). In some aspects, the aqueous steviol glycoside solution further comprises gellan gum. In some aspects, the gellan gum is present at 350 ppm to 1100 ppm.

In some aspects, the individual rebaudioside M concentration is 3000 ppm to 6000 ppm. In some aspects, aqueous steviol glycoside solution comprises greater than 0.3% (wt), 0.4% (wt), 0.5% (wt), 0.6% (wt), 0.7% (wt), 0.8% (wt), 0.9% (wt), 1.0% (wt), 1.25% (wt), 1.5% (wt), 1.75% (wt), 2.0% (wt), or 2.5% (wt) total steviol glycosides. In some aspects, the aqueous steviol glycoside solution comprises less than 50% (wt), 40% (wt), 30% (wt), 20% (wt), 10% (wt), or 5% (wt) of a C1-C4 alcohol. In some aspects, the aqueous steviol glycoside solution is free of the C1-C4 alcohol.

In some aspects, the solubility enhancer comprises mandelic acid or pyromellitic acid.

One aspect provides a beverage composition comprising any one of the aqueous steviol glycoside solutions described above in which the aqueous steviol glycoside solution further comprises one or more of phosphoric acid, citric acid, sodium citrate, and carbonated water.

One aspect provides a sweetener comprising a steviol glycoside composition comprising one or more steviol glycosides and a solubility enhancer in an amount effective to enhance the solubility of at least one of the steviol glycosides, wherein the sweetener is soluble in water without alcohol at a temperature of about 20° C. to about 30° C. at a total steviol glycoside concentration of greater than 0.2% (wt). In some aspects, the solubility enhancer of the sweetener comprises gallic acid. In some aspects, the solubility enhancer is present at a molar ratio of solubility enhancer to steviol glycoside of between 0.5:1 to 7:1

In some aspects, the total steviol glycoside composition comprises rebaudioside A. In some aspects, the total steviol glycoside composition comprises rebaudioside D. In some aspects, the total steviol glycoside composition comprises rebaudioside M. In some aspects, the sweetener further comprises corn starch fiber. In some aspects, the sweetener further comprises gellan gum.

One aspect provides a method for solubilizing a total steviol glycoside composition, the method comprising contacting a steviol glycoside and a solubility enhancer to prepare any of the steviol glycoside solutions described above.

One aspect provides a method for preparing a sweetener comprising preparing any of the sweeteners described above.

### DESCRIPTION OF THE FIGURES

FIG. 1 shows structures of steviol glycosides.

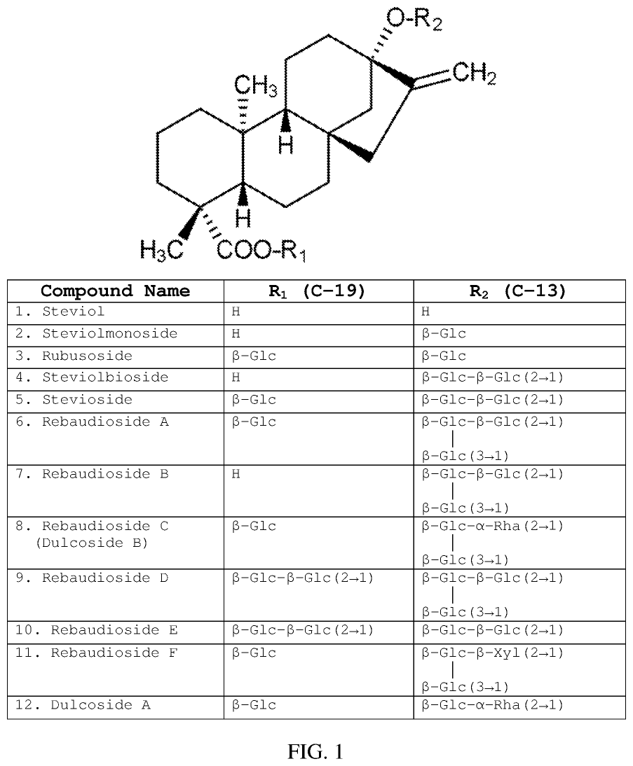

### DETAILED DESCRIPTION

Embodiments of the disclosure described herein are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

For example, some aspects of the disclosure are directed to compositions having an amount of one or more of steviol glycoside solubility enhancers. In one aspect, one or more of steviol glycoside solubility enhancers, when present in a sweetener composition, beverage, food product, etc., provide for enhanced solubility.

The amounts of steviol glycosides and one or more steviol glycoside solubility enhancers in the composition can be expressed in relation to one another, or to the total amount of steviol glycosides, such as by a weight percentage of the total amount of steviol glycosides, or a ratio, or range of ratios, expressed as weight percent, or molar percent

Total steviol glycosides (TSG) is calculated as the sum of the content of all steviol glycosides in a composition on a dry (anhydrous) basis. Unless expressed herein otherwise, an “amount” of steviol glycoside will refer to the percentage by weight (% wt) of the steviol glycoside, or combination thereof.

As discussed herein, the composition can include one or more steviol glycosides and one or more steviol glycoside solubility enhancers, as well as other compounds. Exemplary steviol glycosides include those such as rebaudioside M, rebaudioside D, rebaudioside A, rebaudioside B, rebaudioside N, and/or stevioside. In some aspects, the steviol glycosides rebaudioside M and rebaudioside D can be produced by an engineered organism as the predominant steviol glycosides, and therefore can represent the major portion of the steviol glycosides in the composition. Rebaudioside M or rebaudioside D can, in some aspects, be present in the composition an amount greater than other steviol glycosides.

A steviol glycoside composition that includes one or more steviol glycoside solubility enhancers can optionally be expressed in terms of amounts of rebaudioside M and rebaudioside D. For example, rebaudioside M and rebaudioside D can be present in the composition in a total amount of about 90% (wt) or greater, about 92.5% (wt) or greater, or 95% (wt) or greater, of a total amount steviol glycosides in the composition. Rebaudioside M can be the predominant steviol glycoside in the composition, and can be present, for example, in an amount in the range of about 45% to about 70%, about 50% to about 65%, or about 52.5% to about 62.5% of the total amount steviol glycosides in the composition. Rebaudioside D can be in an amount less than Rebaudioside M, such as in an amount in the range of about 25% to about 50%, about 30% to about 45%, or about 32.5% to about 42.5% of the total amount steviol glycosides in the composition.

The composition can optionally be expressed in terms of amounts of other known steviol glycosides that are present in lower amounts. For example, the composition can include one or more of rebaudioside A, rebaudioside B, or stevioside in an amount of about 1% (wt) or less, about 0.5% (wt) or less, or about 0.25% (wt) or less, of a total amount steviol glycosides in the composition.

The composition can optionally be expressed in terms of the concentration of one or more steviol glycoside(s). Beneficially, it has been found that certain compound(s) can improve solubility of steviol glycosides in an aqueous solution, and therefore compositions can be prepared having a greater concentration of steviol glycosides in solution. As used herein “instantaneous solubility” refers to the solubility of a steviol glycoside, or mixture of steviol glycosides, that are vigorously mixed with water at room temperature (25° C.). As used herein “equilibrium solubility” refers to the solubility of a steviol glycoside, or mixture of steviol glycosides, that are vigorously mixed with deionized water at 80° C. for 15 minutes, cooled to room temperature (25° C.), and then observed at least four days. Clear solutions without precipitates are considered soluble. Unless indicated otherwise herein, the term “solubility” refers to “equilibrium solubility.”

In the absence of compounds that enhance solubility, rebaudioside D has a very low instantaneous solubility (less than 0.08% at room temperature) in water. Upon heating to 80° C. for 15 minutes, rebaudioside D has an equilibrium solubility of 0.08% for at least four days at room temperature. Rebaudioside M has a higher solubility than rebaudioside D. The instantaneous solubility of rebaudioside M is about 0.13%, and its equilibrium solubility is about 0.2% at room temperature.

Therefore, the presence of one or more steviol glycoside solubility enhancers can improve the solubility of one or more steviol glycosides by 1, 2, 3, 4, 5, 10, 15, 20, 50 or 100 times.

In some modes of practice, one or more steviol glycoside solubility enhancers can be enriched in a composition. The term “enriched” refers to an increase in the amount of one or more steviol glycoside solubility enhancers relative to one or more other compounds that are present in a composition. A composition that is enriched for one or more steviol glycoside solubility enhancers can be combined with a steviol glycoside composition to improve solubility of those steviol glycosides.

Accordingly, other aspects of the disclosure provides a method of enhancing the solubility of a steviol glycoside in an aqueous composition comprising a step of providing an aqueous composition comprising a steviol glycoside, e.g., rebaudioside A, rebaudioside B, rebaudioside M, rebaudioside D, rebaudioside I, rebaudioside Q, rebaudioside N, or stevioside, or any combination thereof, and one or more steviol glycoside solubility enhancers. For example, the steviol glycoside can be added to a composition that has the one or more steviol glycoside solubility enhancers, the steviol glycoside and the one or more steviol glycoside solubility enhancers may be mixed, or the one or more steviol glycoside solubility enhancers can be added to a composition having the steviol glycoside.

Sweetener compositions (also referred to as sweetening compositions), as used herein, refers to compositions that include one or more steviol glycosides and one or more steviol glycoside solubility enhancers. Thus, one or more steviol glycoside(s) such as Reb B, Reb M and/or Reb D can be present in a greater amount in the composition, such as greater than about 75%, greater than about 80%, greater than about 85%, greater than about 90%, greater than about 95%, or greater than about 99% of the total amount of steviol glycosides in the composition.

In one aspect, one or more steviol glycoside solubility enhancers are present in a sweetener composition at a molar ratio of steviol glycoside to steviol glycoside solubility enhancer of about 1:1, 1:0.9, 1:0.8, 1:0.7, 1:0.6, 1:0.5, 1:0.4, 1:0.3, 1:0.2, or 1:0.1. In one aspect, one or more steviol glycoside solubility enhancers are present in a sweetener composition at a molar ratio of steviol glycoside to steviol glycoside solubility enhancer of about 1:1, 1:2, 1:3, 1:4, 1:5, 1:6, 1:7, 1:8, 1:9, or 1:10. In one aspect, one or more steviol glycoside solubility enhancers are present in a sweetener composition at a molar ratio of steviol glycoside to steviol glycoside solubility enhancer of about 1:0.5 to 1:7.

The sweetener composition can optionally include another sweetener, an additive, a liquid carrier, or combinations thereof. Sweetener compositions are used to sweeten other compositions (sweetenable compositions) such as foods, beverages, medicines, oral hygiene compositions, nutraceuticals, and the like.

Sweetenable compositions, as used herein, mean substances which are contacted with the mouth of man or animal, including substances which are taken into but subsequently ejected from the mouth (such as a mouthwash rinse) and substances which are drunk, eaten, swallowed or otherwise ingested, and are suitable for human or animal consumption when used in a generally acceptable range. Sweetenable compositions are precursor compositions to sweetened compositions and are converted to sweetened compositions by combining the sweetenable compositions with at least one sweetening composition and optionally one or more other sweetenable compositions and/or other ingredients.

Sweetened compositions, as used herein, mean substances that are derived from constituents including at least one sweetenable composition and at least one sweetener composition. In some modes of practice, a sweetened composition may be used itself as a sweetening composition to sweeten still yet further sweetenable compositions. In some modes of practice, a sweetened composition may be used as a sweetenable composition that is further sweetened with one or more additional sweetening compositions. For example, a beverage with no sweetener component is a type of sweetenable composition. A sweetener composition can be added to the un-sweetened beverage, thereby providing a sweetened beverage. The sweetened beverage is a type of sweetened composition.

In some preparations, steviol glycoside provides the sole sweetener component in a sweetening composition.

In some aspects, a sweetening composition comprises steviol glycosides in an amount effective to provide a sweetness strength equivalent to a specified amount of sucrose. The amount of sucrose in a reference solution may be described in degrees Brix (° Bx). One degree Brix is 1 gram of sucrose in 100 grams of solution and represents the strength of the solution as percentage by weight (% w/w). For example, a sweetener composition contains one or more steviol glycosides in an amount effective to provide a sweetness equivalent from about 0.50 to 14 degrees Brix of sugar when present in a sweetened composition, such as, for example, from about 5 to about 11 degrees Brix, from about 4 to about 7 degrees Brix, or about 5 degrees Brix.

The amount of steviol glycosides in the sweetener composition may vary. Steviol glycosides can be present in a sweetener composition in any amount to impart the desired sweetness when the sweetener composition is incorporated into a sweetened composition. For example, Reb M and/or Reb D are present in the sweetener composition in an amount effective to provide total steviol glycoside concentration from about 1 ppm to about 10,000 ppm when present in a sweetened composition, In another aspect, the steviol glycosides are present in the sweetener composition in an amount effective to provide a steviol glycoside concentration in the range of about 10 ppm to about 1,000 ppm, more specifically about 10 ppm to about 800 ppm, about 50 ppm to about 800 ppm, about 50 ppm to about 600 ppm, or about 200 ppm to about 500 ppm.

In one aspect, steviol glycosides other than Reb D, Reb M, Reb G, Reb O, Reb N, and/or Reb E, or other than Reb D, Reb M, Reb B and/or Reb A, or other than Reb D and/or Reb M, are present in a sweetened composition at about 0.05 to 70 wt % of the total content of the sweetener composition; e.g., about 0.1 to 50, 0.5 to 70, 1 to 50, 1 to 35, 2 to 25, 3 to 20, 5 to 15, 0.1 to 15, 0.5 to 10, 1 to 5%, etc. In one aspect, steviol glycosides other than Reb D, Reb M, Reb G, Reb O, Reb N, and/or Reb E, or other than Reb D, Reb M, Reb B and/or Reb A or other than Reb D and/or Reb M, are at a weight ratio of the total of all other glycosides of 1:1 to 1:20, 1:1.5 to 1:15, 1:2 to 1:10, 1:2.5 to 1:7.5, or 1:3 to 1:5, in a sweetened composition.

Unless otherwise expressly stated, ppm is on a weight basis.

### Exemplary Steviol Glycoside Solubility Enhancers and Formulations

Examples of solubility enhancer include: gallic acid, mandelic acid, pyromellitic acid, isomers, derivatives, and salts thereof.

Gallic acid has the structure:

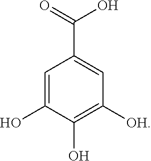 [SMILES: O=C(O)c1cc(O)c(O)c(O)c1]

Mandelic acid has the structure:

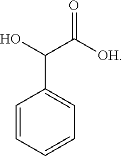 [SMILES: O=C(O)C(O)c1ccccc1]

Pyromellitic acid has the structure:

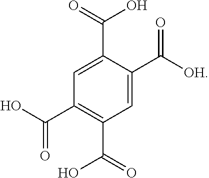 [SMILES: O=C(O)c1cc(C(=O)O)c(C(=O)O)cc1C(=O)O]

In some aspects, an amount of solubility enhancer effective to enhance solubility comprises an amount such that the total steviol glycoside remains in solution. In some aspects, an amount of solubility enhancer effective to enhance solubility comprises an amount such that the total steviol glycoside remains in solution over a period of time. For example, an amount of solubility enhancer effective to enhance solubility comprises an amount such that the total steviol glycoside remains in solution over at least 1, 2, 3, 4, 5, 6, 7, 8, 9, or 10 days. In some aspects, an amount of solubility enhancer effective to enhance solubility comprises an amount such that the total steviol glycoside remains in solution for at least three days when stored at room temperature. In some aspects, an amount of solubility enhancer effective to enhance solubility comprises an amount such that the total steviol glycoside remains in solution for at least three days when stored at a temperature of about 20° C. to about 30° C., or about 23° C. to about 28° C. Examples 2-7 and 8 below provide exemplary methods for determining the amount of solubility enhancer effective to enhance solubility comprises an amount such that the total steviol glycoside remains in solution.

In some aspects, an amount of solubility enhancer effective to increase solubility of the steviol glycoside is an amount such that the solubility enhancer comprises a 1:0.3 to 1:3 molar ratio of steviol glycoside to solubility enhancer. In other aspects, an amount of solubility enhancer effective to increase solubility of the steviol glycoside is an amount such that the solubility enhancer comprises a 1:1 to 1:3 molar ratio of steviol glycoside to solubility enhancer. An amount of solubility enhancer effective to increase solubility of the steviol glycoside can be an amount such that the solubility enhancer comprises a molar ratio of steviol glycoside to solubility enhancer of 1:0.1 to 1:10. In some aspects an amount of solubility enhancer effective to increase solubility of the steviol glycoside can be an amount such that the solubility enhancer comprises a molar ratio of steviol glycoside to solubility enhancer of about 1:0.1 to 1:5, about 1:0.5 to 1:4, about 1:0.3 to 1:3, about 1:1 to 1:3, or about 1:0.5 to 1:7. In other aspects an amount of solubility enhancer effective to increase solubility of the steviol glycoside can be an amount such that the solubility enhancer comprises a molar ratio of steviol glycoside to solubility enhancer of about 1:0.1, 1:0.5, 1:1, 1:2, 1:3, 1:4, 1:5, 1:6, 1:7, 1:8, 1:9, or 1:10. In some aspects, an amount of solubility enhancer effective to increase solubility of the steviol glycoside can be an amount such that the solubility enhancer comprises a molar ratio of steviol glycoside to solubility enhancer of about 1:0.3 to 1:3.

In some aspects, an amount of solubility enhancer effective to increase solubility of the steviol glycoside is a final concentration of solubility enhancer of greater than 100 ppm, 200 ppm, 300 ppm, 400 ppm, 700 ppm, 800 ppm, 900 ppm, or 1000 ppm. The final concentration of solubility enhancer can be greater than 1100 ppm, 1200 ppm, 1300 ppm, 1400 ppm, 1500 ppm, 1600 ppm, 1700 ppm, 1800 ppm, or 1900 ppm. The final concentration of solubility enhancer can be greater than 2100 ppm, 2200 ppm, 2300 ppm, 2400 ppm, 2500 ppm, 2600 ppm, 2700 ppm, 2800 ppm, or 2900 ppm. The final concentration of solubility enhancer can be greater than 3100 ppm, 3200 ppm, 3300 ppm, 3400 ppm, 3500 ppm, 3600 ppm, 3700 ppm, 3800 ppm, or 3900 ppm. The final concentration of solubility enhancer can be greater than 3000 ppm, 4000 ppm, 5000 ppm, 6000 ppm, 7000 ppm, 8000 ppm, or 9000 ppm. The final concentration of solubility enhancer can be greater than 1%, 2%, 3%, 4%, 5%, 6%, 7%, 8%, 9%, 10%, or higher. The final concentration of solubility enhancer can be greater than 10%, 20%, 30%, 40%, 50%, 60%, 70%, 80%, 90% or higher.

In some aspects, an amount of solubility enhancer effective to enhance solubility comprises an amount such that the total steviol glycoside remains in solution in an aqueous solution that comprises less than 50% (wt), 40% (wt), 30% (wt), 20% (wt), 10% (wt), or 5% (wt) of a C1-C4 alcohol. In some aspects, an amount of solubility enhancer effective to enhance solubility comprises an amount such that the total steviol glycoside remains in solution in an aqueous solution that is free of a C1-C4 alcohol. C1-C4 alcohol can include methanol, ethanol, propanol, isopropanol, and/or butanol.

In some aspects, a sweetener composition having the steviol glycosides and one or more solubility enhancers, also contain one or more additional compounds. The compounds can include fiber, including dietary fibers in any suitable amount. For example, the sweetener composition can include corn starch fiber. In some aspects, the corn starch fiber is present in an amount that enhances solubility of the steviol glycoside. In some aspects, the corn starch fiber is present at 0.05% (wt) to 0.5% (wt). The compounds can also include gelling agents including for example gellan gum. The gellan gum can be present at any suitable amount. In some aspects, the gellan gum is present in an amount that enhances solubility of the steviol glycoside. In some aspects, the gellan gum is present at 350 ppm to 1100 ppm.

In some aspects, a sweetener composition having the steviol glycosides and one or more steviol glycoside solubility enhancers, also contain one or more additional non-steviol glycoside sweetener compound(s). The non-steviol glycoside sweetener compounds can be any type of sweetener, for example, a sweetener obtained from a plant or plant product, or a physically or chemically modified sweetener obtained from a plant, or a synthetic sweetener.

For example, exemplary non-steviol glycoside sweeteners include sucrose, fructose, glucose, erythritol, maltitol, lactitol, sorbitol, mannitol, xylitol, tagatose, trehalose, galactose, rhamnose, cyclodextrin (e.g., a-cyclodextrin, β-cyclodextrin, and γ-cyclodextrin), and other carbohydrate sweeteners. The steviol glycosides and carbohydrate sweetener may be present in any weight ratio, such as, for example, from about 1:14,000 to about 100:1, such as, for example, about 1:100. Carbohydrates are present in the sweetener composition in an amount effective to provide a concentration from about 100 ppm to about 140,000 ppm when present in a sweetened composition, such as, for example, a beverage.

In other aspects, the sweetener composition including the steviol glycosides and one or more steviol glycoside solubility enhancers, additionally include one or more synthetic sweeteners. In one aspect, a synthetic has a sweetness potency greater than sucrose, fructose, and/or glucose, yet has less calories than sucrose, fructose, and/or glucose. Exemplary synthetic non-steviol glycoside sweeteners include include sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof. In aspects where the sweetener composition includes the steviol glycosides and synthetic sweetener, the synthetic sweetener can be present in an amount effective to provide a concentration from about 0.3 ppm to about 3,500 ppm when present in a sweetened composition, such as, for example, a beverage.

The weight ratio of the total amount of sweetener compositions used to sweeten a sweetened composition can vary over a wide range. In many aspects, this weight ratio is in the range from 1:10,000 to 10:1.

In addition to the steviol glycosides and one or more steviol glycoside solubility enhancers, the sweetener compositions can optionally include a liquid carrier, binder matrix, additional additives, and/or the like.

In one aspect, the sweetener compositions with steviol glycosides and one or more steviol glycoside solubility enhancers contain one or more polyols. Exemplary polyols include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect the taste of the sweetener composition.

Exemplary amounts of polyol provide a concentration in the range of about 100 ppm to about 250,000 ppm when present in a sweetened composition, more specifically about 400 ppm to about 80,000 ppm, or about 5,000 ppm to about 40,000 ppm, based on the total weight of the sweetened composition.

Exemplary bitter compound additives include, but are not limited to, caffeine, quinine, urea, bitter orange oil, naringin, quassia, and salts thereof.

Exemplary flavorant and flavoring ingredient additives, but are not limited to, vanillin, vanilla extract, mango extract, cinnamon, citrus, coconut, ginger, viridiflorol, almond, menthol (including menthol without mint), grape skin extract, and grape seed extract. In some aspects, a flavorant is present in the sweetener composition in an amount effective to provide a concentration from about 0.1 ppm to about 4,000 ppm when present in a sweetened composition, such as, for example, a beverage, based on the total weight of the sweetened composition.

Exemplary alcohol additives include, but are not limited to, ethanol. In some aspects, an alcohol additive is present in the sweetener composition in an amount effective to provide a concentration from about 625 ppm to about 10,000 ppm when present in a sweetened composition, such as, for example, a beverage, based on the total weight of the sweetened composition.

The sweetener composition can also contain one or more functional ingredients, which provide a real or perceived heath benefit to the composition. Functional ingredients include, but are not limited to, saponins, antioxidants, dietary fiber sources, fatty acids, vitamins, glucosamine, minerals, preservatives, hydration agents, probiotics, prebiotics, and combinations thereof.

As used herein “antioxidant” refers to any substance which inhibits, suppresses, or reduces oxidative damage to cells and biomolecules. Without being bound by theory, it is believed that antioxidants inhibit, suppress, or reduce oxidative damage to cells or biomolecules by stabilizing free radicals before they can cause harmful reactions. As such, antioxidants may prevent or postpone the onset of some degenerative diseases.

As used herein, the at least one vitamin may be single vitamin or a plurality of vitamins as a functional ingredient for the sweetener and sweetened compositions provided herein. Suitable vitamins include, vitamin A, vitamin D, vitamin E, vitamin K, vitamin B1, vitamin B2, vitamin B3, vitamin B5, vitamin B6, vitamin B7, vitamin B9, vitamin B 12, and vitamin C Many of vitamins also have alternative chemical names, non-limiting examples of which are provided below.

In certain aspects, the functional ingredient comprises at least one preservative. In particular aspects of this disclosure, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone.

Generally, the amount of functional ingredient in the sweetener composition or sweetened composition varies widely depending on the particular sweetener composition or sweetened composition and the desired functional ingredient. Those of ordinary skill in the art will readily acertain the appropriate amount of functional ingredient for each sweetener composition or sweetened composition.

Steviol glycosides having one or more steviol glycoside solubility enhancers can be incorporated in any known edible material (referred to herein as a “sweetenable composition”) or other composition intended to be ingested and/or contacted with the mouth of a human or animal, such as, for example, pharmaceutical compositions, edible gel mixes and compositions, dental and oral hygiene compositions, foodstuffs (confections, condiments, chewing gum, cereal compositions, baked goods, baking goods, cooking adjuvants, dairy products, and tabletop sweetener compositions), beverages, and other beverage products (e.g., beverage mixes, beverage concentrates, etc.).

In one aspect, a sweetened composition is derived from ingredients comprising a sweetenable composition and a composition having steviol glycosides and one or more steviol glycoside solubility enhancers. In another aspect, the sweetened composition is derived from ingredients comprising a sweetener composition comprising steviol glycosides and one or more steviol glycoside solubility enhancers. The sweetened compositions can optionally include one or more additives, liquid carriers, binders, sweeteners, functional ingredients, other adjuvants, and combinations thereof.

In one aspect, an edible gel or edible gel mix comprises a sweetener composition comprising steviol glycosides and one or more steviol glycoside solubility enhancers. The edible gel or edible gel mixes can optionally include additives, functional ingredients or combinations thereof. One or more one or more steviol glycoside solubility enhancers, e.g., a mixture of steviol glycoside solubility enhancers, may be combined with one or more steviol glycosides, such as Reb D or Reb M, so as to constitute a sweetener composition of the present disclosure. However, in many aspects, a sweetener composition comprises one or more steviol glycoside solubility enhancers, or a mixture thereof, with one or more steviol glycosides, such as Reb D or Reb M and one or more other ingredient(s) that is not a steviol glycoside.

In one aspect, a dental composition comprises a sweetener composition comprising comprising steviol glycosides and one or more steviol glycoside solubility enhancers. Dental compositions generally comprise an active dental substance and a base material. A sweetener composition comprising steviol glycosides and one or more steviol glycoside solubility enhancers can be used as the base material to sweeten the dental composition. The dental composition may be in the form of any oral composition used in the oral cavity such as mouth freshening agents, gargling agents, mouth rinsing agents, toothpaste, tooth polish, dentifrices, mouth sprays, teeth-whitening agent, dental floss, compositions to treat one or more oral indications (e.g., gingivitis), and the like, for example.

Foodstuffs include, but are not limited to, confections, condiments, chewing gum, cereal, baked goods, and dairy products. In a particular aspect, steviol glycosides are present in the confection in an amount in the range of about 30 ppm to about 6000 ppm, about 1 ppm to about 10,000 ppm, or about 10 ppm to about 5000 ppm, about 500 ppm to about 5000 ppm, about 100 ppm to about 5000 ppm, about 100 ppm to about 7000 ppm, about 200 ppm to about 4000 ppm, about 500 ppm to 7500 ppm, about 1000 ppm to about 8000 ppm, about 2000 ppm to about 5000 ppm, about 3000 ppm to about 7000 ppm or about 4000 ppm to about 6000 ppm of the confection.

In another aspect, a condiment comprises steviol glycosides and one or more steviol glycoside solubility enhancers. In another aspect a condiment comprises a sweetener composition comprising steviol glycosides and one or more steviol glycoside solubility enhancers. In one aspect, a chewing gum composition comprises a sweetener composition comprising steviol glycosides and one or more steviol glycoside solubility enhancers.

In one aspect, a cereal composition comprises a sweetener composition comprising steviol glycosides and one or more steviol glycoside solubility enhancers. In another aspect, a baked good comprises a sweetener composition comprising steviol glycosides one or more steviol glycoside solubility enhancers. In one aspect, a dairy product comprises a sweetener composition comprising comprising steviol glycosides and one or more steviol glycoside solubility enhancers.

Tabletop sweetener compositions containing steviol glycosides and including compounds one or more steviol glycoside solubility enhancers, are also contemplated herein. The tabletop composition can further include a variety of other ingredients, including but not limited to at least one bulking agent, additive, anti-caking agent, functional ingredient or combination thereof. Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, in accordance with still other aspects, granulated sugar (sucrose) or other caloric sweeteners such as crystalline fructose, other carbohydrates, or sugar alcohol can be used as a bulking agent due to their provision of good content uniformity without the addition of significant calories.

A tabletop sweetener composition also may be embodied in the form of a liquid, wherein a sweetener composition comprising steviol glycoside and including one or more steviol glycoside solubility enhancers, is combined with a liquid carrier. Suitable non-limiting examples of carrier agents for liquid tabletop functional sweeteners include water, alcohol, polyol, glycerin base or citric acid base dissolved in water, and mixtures thereof.

In one aspect, the sweetened composition is a beverage product comprising steviol glycosides and including one or more steviol glycoside solubility enhancers. As used herein a “beverage product” is a ready-to-drink beverage, a beverage concentrate, a beverage syrup, frozen beverage, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts, smoothies and combinations thereof.

Beverage concentrates and beverage syrups can be prepared with an initial volume of liquid matrix (e.g. water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

In one aspect, a beverage contains a sweetener composition comprising steviol glycosides and including one or more steviol glycoside solubility enhancers. Any sweetener composition comprising steviol glycosides and one or more steviol glycoside solubility enhancers detailed herein can be used in the beverages. In another aspect, a method of preparing a beverage comprises combining a liquid matrix, steviol glycosides and one or more steviol glycoside solubility enhancers. The method can further comprise addition of one or more sweeteners, additives and/or functional ingredients. In still another aspect, a method of preparing a beverage comprises combining a liquid matrix and a sweetener composition comprising steviol glycosides and one or more steviol glycoside solubility enhancers.

In another aspect, a beverage contains a sweetener composition containing steviol glycosides, wherein the steviol glycosides are present in the beverage in an amount ranging from about 1 ppm to about 10,000 ppm, such as, for example, from about 25 ppm to about 800 ppm. In another aspect, steviol glycosides are present in the beverage in an amount ranging from about 100 ppm to about 600 ppm. In yet other aspects, steviol glycosides are present in the beverage in an amount ranging from about 100 to about 200 ppm, from about 100 ppm to about 300 ppm, from about 100 ppm to about 400 ppm, or from about 100 ppm to about 500 ppm. In still another aspect, steviol glycosides are present in the beverage in an amount ranging from about 300 to about 700 ppm, such as, for example, from about 400 ppm to about 600 ppm. In a particular aspect, steviol glycosides are present in the beverage in an amount of about 500 ppm.

In one aspect, the composition is a beverage and the total glycoside content in the beverage is about 50 to 1500 ppm, or 100 to 1200 ppm, 200 to 1000 ppm, 300 to 900 ppm, 350 to 800 ppm, 400 to 600 ppm, or 450 to 550 ppm. In one aspect, steviol glycosides other than Reb D, Reb M, Reb B and/or Reb A, or other than Reb D and/or Reb B, and optionally other than Reb G, Reb O, Reb N, and/or Reb E, e.g., one or more steviol glycoside solubility enhancers, are present in a beverage at about at least 1 ppm to about 600 ppm, e.g., about 50 ppm to about 500 ppm, including at least 1, 5, 10, 20, 30, 40, 50, 125, 150, 150, 175, or 200 ppm. In one aspect, steviol glycosides other than Reb D, Reb M, Reb B and/or Reb A, or other than Reb D and/or Reb B, and optionally other than Reb G, Reb O, Reb N, and/or Reb E, are present in a beverage at about 1 to 600 ppm 10 to 400, 50 to 200, 75 to 150, 5 to 200, 10 to 100, 20 to 90, 30 to 80 ppm, and the like. In one aspect, steviol glycosides other than Reb D, Reb M, Reb B and/or Reb A, are present in a beverage at about 1 to 600 ppm 10 to 400, 50 to 200, 75 to 150, 5 to 200, 10 to 100, 20 to 90, 30 to 80 ppm, and the like.

The invention will be further described by the following non-limiting examples.

### EXAMPLES

### Example 1

### HPLC Analytical Methods

Solubility of various combinations of steviol glycosides and solubility enhancers were assayed by HPLC (high performance liquid chromatography). In general, solutions of steviol glycosides and solubility enhancers were prepared and then assayed by HPLC after varying shelf times. The HPLC assays indicated the amount of particular steviol glycosides present in a soluble fraction of the respective solutions at the end of the respective shelf times. The HPLC was equipped with two Agilent ED-C18 columns (4.6 mm×150 mm, 2.7 μm) connected in series. Chromatography runs were performed on the two Agilent ED-C18 columns at a flow rate of 0.6 ml/min with a Mobile Phase A (0.01% trifluoroacetic acid in water) and a Mobile Phase B (acetonitrile) using a gradient as indicated below in Table 1. The total run time was 35 minutes, the column temperature was 50° C., the sample temperature was 20° C., and the sample injection volume was 10 μL. Standard samples of the respective steviol glycosides and the respective solubility enhancers were first assayed and then the various solutions were assayed and compared to the standard samples.

TABLE 1

| Time (min.) | Mobile Phase A | Mobile Phase B |
|---|---|---|
| 0 | 68 | 32 |
| 15 | 68 | 32 |
| 22 | 50 | 50 |
| 26.5 | 50 | 50 |
| 27 | 10 | 90 |
| 30 | 10 | 90 |
| 30.5 | 68 | 32 |
| 35 | 68 | 32 |

### Example 2

Soluble Solution of Gallic Acid, Corn Starch Fiber, and Steviol Glycoside

Gallic acid was obtained (Sigma Aldrich, about 97.5% purity). Gallic acid, 0.035 g, and corn starch fiber, 0.5 ml, were mixed with 100 mL of Millipore water until dissolved. A spray dried steviol glycoside mix, 0.4 g, (about 95% total steviol glycosides with about 75% Reb M and about 5% Reb D), was added and mixed for 10 min. The spray dried steviol glycoside was completely dissolved within 10 min. and produced a clear solution. The solution of gallic acid, corn starch fiber, and steviol glycoside mix remained clear for more than 3 days. This experiment showed that a solution of gallic acid, corn starch fiber, and spray dried steviol glycoside mix was soluble in water for at least 3 days.

### Example 3

### Soluble Solution of Gallic Acid, Gellan Gum, and Steviol Glycoside

Gallic acid was obtained (Sigma Aldrich, about 97.5% purity). Gallic acid, 0.035 g, was mixed with 50 mL of Millipore water until dissolved. Gellan gum, 0.01 g, and a spray dried steviol glycoside mix, 0.2 g, (about 95% total steviol glycosides with about 75% Reb M and about 5% Reb D) was added and mixed for 10 min. The gellan gum and spray dried steviol glycoside was completely dissolved within 10 min. and produced a clear solution. The solution of gallic acid, gellan gum, and steviol glycoside mix remained clear for more than 3 days. The solution of gallic acid, gellan gum, and steviol glycoside mix was assayed 24 h after mixing by HPLC as described above. The assay indicated Rebaudoside M at a 0.27% by weight concentration and Rebaudoside D at a 0.056% by weight concentration for a total of 0.326% by weight steviol glycoside concentration. This experiment showed that a solution of gallic acid, gellan gum, and spray dried steviol glycoside mix was soluble in water for at least 3 days.

### Example 4

### Soluble Solution of Gallic Acid and Steviol Glycoside

Gallic acid was obtained (Sigma Aldrich, about 97.5% purity). Gallic acid, 0.035 g, was mixed with 50 mL of Millipore water until dissolved. A spray dried steviol glycoside mix, 0.2 g (about 95% total steviol glycosides with about 75% Reb M and about 5% Reb D), F was added and mixed for 10 minutes. The solution of gallic acid and steviol glycoside mix remained clear for more than 3 days. The solution of gallic acid and steviol glycoside mix was assayed 24 hours after mixing by HPLC as described above. The assay indicated Rebaudoside M at a 0.297% by weight concentration and Rebaudoside D at a 0.06% by weight concentration for a total of 0.357% by weight steviol glycoside concentration. This experiment showed that a solution of gallic acid and spray dried steviol glycoside mix was soluble in water for at least 3 days.

### Example 5

### Soluble Solution of Gallic Acid, Corn Starch Fiber, and Steviol Glycoside

Gallic acid was obtained (Sigma Aldrich, about 97.5% purity). Gallic acid, 0.035 g, was mixed with 50 mL of Millipore water until dissolved. Corn starch fiber, 0.2 ml, and a spray dried steviol glycoside mix, 0.2 g (about 95% total steviol glycosides with about 75% Reb M and about 5% Reb D), was added and mixed for 10 minutes. The solution of gallic acid and steviol glycoside mix remained clear for more than 7 days. The solution of gallic acid, corn starch fibers and steviol glycoside mix was assayed 24 hours after mixing by HPLC as described above. The assay indicated Rebaudoside M at a 0.278% by weight concentration and Rebaudoside D at a 0.057% by weight concentration for a total of 0.335% by weight steviol glycoside concentration. This experiment showed that a solution of gallic acid, corn starch fibers, and spray dried steviol glycoside mix was soluble in water for at least 7 days.

### Example 6

### Soluble Solution of Gallic Acid, Corn Starch Fibers, and Steviol Glycoside

Gallic acid was obtained (Sigma Aldrich, about 97.5% purity). Gallic acid, 0.11 g, was mixed with 100 mL of Millipore water until dissolved. Corn starch fiber, 0.05 ml, and a spray dried steviol glycoside mix, 0.43 g (about 95% total steviol glycosides with about 75% Reb M and about 5% Reb D), was added and mixed for 10 min. The solution of gallic acid and steviol glycoside mix remained clear for more than 10 days. The solution of gallic acid, corn starch fibers and steviol glycoside mix was assayed 24 hours after mixing by HPLC as described above. The assay indicated Rebaudoside M at a 0.289% by weight concentration and Rebaudoside D at a 0.052% by weight concentration for a total of 0.341% by weight steviol glycoside concentration. This experiment showed that a solution of gallic acid, corn starch fibers, and spray dried steviol glycoside mix was soluble in water for at least 10 days.

### Example 7

### Soluble Solution of Gallic Acid and Steviol Glycoside

Gallic acid was obtained (Sigma Aldrich, about 97.5% purity). Gallic acid, 0.11 g, was mixed with 100 mL of Millipore water until dissolved. A spray dried steviol glycoside mix, 0.43 g (about 95% total steviol glycosides with about 75% Reb M and about 5% Reb D), was added and mixed for 10 min. The solution of gallic acid and steviol glycoside mix remained clear for more than 3 days. The solution of gallic acid and steviol glycoside mix was assayed 24 hours after mixing by HPLC as described above. The assay indicated Rebaudoside M at a 0.279% by weight concentration and Rebaudoside D at a 0.051% by weight concentration for a total of 0.33% by weight steviol glycoside concentration. This experiment showed that a solution of gallic acid and spray dried steviol glycoside mix was soluble in water for at least 3 Days.

### Example 8

Solubility of Rebaudoside B with Gallic Acid

Gallic acid was obtained (Sigma Aldrich, about 97.5% purity). Gallic acid, 0.4 g, and 2 g of Rebaudoside B were mixed with 50 mL of a 50%/50% ethanol-water solution for 24 hours, filtered, and dried under a vacuum. Crystals of Rebaudoside B and gallic acid resulted. A kinetic/instant solubility was measured for the resulting crystals by HPLC. At less than 48 h the crystals possessed a kinetic/instant solubility of 550 ppm, at 55 hours the crystals possessed a kinetic/instant solubility of 500 ppm, and at 72 hours the crystals possessed a kinetic/instant solubility of 140 ppm. A comparison with only Rebaudoside B and without gallic acid was also performed. 2 g of Rebaudoside B was mixed with 50 mL of a 50%/50% ethanol-water solution for 24 hours, filtered, and dried under a vacuum. Crystals of Rebaudoside B resulted. A kinetic/instant solubility was measured for the resulting crystals by HPLC. At less than 48 hours the crystals possessed a kinetic/instant solubility of 500 ppm, at 55 hours the crystals possessed a kinetic/instant solubility of 220 ppm, and at 72 hours the crystals possessed a kinetic/instant solubility of 130 ppm. This experiment showed that crystals comprising a combination of gallic acid and Rebaudoside B possessed a higher kinetic/instant solubility than crystals comprising Rebaudoside B alone.

### Example 9

### Solubility of Steviol Glycoside with Mandelic Acid and Pyromellitic Acid

The solubilities of various steviol glycosides mixtures in combination with mandelic acid and pyromellitic acid were tested. For each of mandelic acid and pyromellitic acid, solutions were prepared by adding steviol glycoside (about 95% total steviol glycosides with about 75% Reb M and about 5% Reb D) to a solution of the respective acid. The samples were prepared with a total concentration of the steviol glycoside mixture of 0.3% by weight and a molar ratio of acid to steviol glycoside of 5:1, 2:1, 1:1, 0.5:1, 0.25:1, 0.1:1. Similar samples were also prepared of individual steviol glycosides with each of the respective organic acids. Each sample was stirred on a magnetic stir plate for 30-60 minutes, heated to 75° C., and then cooled to room temperature. A pH of each sample was measured and the samples were observed for precipitation. Mandelic acid and pyromellitic acid were shown to promote a soluble solution of a 0.3% steviol glycoside mixture over 3 days at a 5:1 molar ratio of acid to steviol glycoside.

### Mandelic Acid

Samples of mandelic acid and steviol glycoside (about 95% total steviol glycosides with about 75% Reb M and about 5% Reb D) were prepared as described above. Mandelic acid was obtained (Sigma Aldrich, 99% purity). Mandelic acid was dissolved in Millipore water and then a steviol glycoside mix was added and the sample stirred for approximately 30 minutes. The sample was then heated to 75° C. and allowed to cool to room temperature. Samples were prepared with a final steviol glycoside concentration of 0.3% by weight (2.35 mM) and at a 5:1 and 2:1 molar ratio of acid to steviol glycoside. A pH of each sample was measured. A turbidity of each sample was measured in NTU (Nephelometric Turbidity Units)(measured with Turbiscan LA10 Expert, Formulaction S.A.). The results are shown in Table 2. These experiments show that a sample of mandelic acid and 0.3% steviol glycoside was soluble for at least 3 days.

TABLE 2

| | pH | | | | |
|---|---|---|---|---|---|
| | on | | | | |
| Sample | Day 0 | Day 0 | Day 2 | Day 3 | Day 4 |
| Mandelic acid (5:1 | 3.20 | 1.07 NTU | Clear (some | Clear | Clear |
| molar ratio acid to | | | floating dust) | | 1.42 NTU |
| steviol glycoside), 0.3% | | | 0.944 NTU | | |
| steviol glycoside | | | | | |
| Mandelic acid (2:1 | 3.36 | 0.620 NTU | Clear | Clear (some | Clear |
| molar ratio acid to | | | 0.672 NTU | floating dust) | 1.58 NTU |
| steviol glycoside), | | | | | |
| 0.3% steviol glycoside | | | | | |

### Pyromellitic Acid

Samples of pyromellitic acid and a steviol glycoside mix were prepared as described above. Pyromellitic acid was obtained (Sigma Aldrich, about 96% purity). Pyromellitic acid was dissolved in Millipore water and then a steviol glycoside mix (about 95% total steviol glycosides with about 75% Reb M and about 5% Reb D) was added and the sample stirred for approximately 30 minutes. The sample was then heated to 75° C. and allowed to cool to room temperature. Samples were prepared with a final steviol glycoside concentration of 0.3% by weight (2.35 mM) and at a 5:1 and 2:1 molar ratio of acid to steviol glycoside. A pH of each sample was measured. A turbidity of each sample was measured in NTU (Nephelometric Turbidity Units) (measured with Turbiscan LA10 Expert, Formulaction S.A.). Each sample was observed for solubility. The results are shown in Table 3. These experiments show that a sample of pyromellitic acid and 0.3% steviol glycoside was soluble for at least 3 days.

TABLE 3

| | pH | | | | |
|---|---|---|---|---|---|
| | on | | | | |
| Sample | Day 0 | Day 0 | Day 2 | Day 3 | Day 4 |
| Pyromellitic acid (5:1 | 2.50 | 0.804 NTU | Clear | Clear | Clear |
| molar ratio acid to | | | 0.790 NTU | | 0.910 NTU |
| steviol glycoside), | | | | | |
| 0.3% steviol glycoside | | | | | |
| Pyromellitic acid (2:1 | 2.76 | 0.762 NTU | Clear | Clear (some | Clear |
| molar ratio acid to | | | 0.780 NTU | floating dust) | 1.47 NTU |
| steviol glycoside), | | | | | |
| 0.3% steviol glycoside | | | | | |

### Comparison of Mandelic Acid and Pyromellitic Acid at 1:1 or a 1:0.5 Molar Ratio of Acid to Steviol Glycoside

Samples of each of mandelic acid (Sigma Aldrich, 99%) and pyromellitic acid (Sigma Aldrich, 96%) were prepared with steviol glycoside (about 95% total steviol glycosides with about 75% Reb M and about 5% Reb D). Each acid was dissolved in Millipore water and then a steviol glycoside mix was added and each sample stirred for approximately 30 minutes. Each sample was then heated to 75° C. and allowed to cool to room temperature. Samples were prepared with a final steviol glycoside concentration of 0.3% by weight (2.35 mM) and at a 1:1 or a 0.5:1 molar ratio of acid to steviol glycoside as shown in Table 4. A pH of each sample was measured. A turbidity of each sample was measured in NTU (Nephelometric Turbidity Units)(measured with Turbiscan LA10 Expert, Formulaction S.A.). Each sample was observed for solubility. The solubility results for each sample are shown in Table 5. These experiments showed that 0.3% steviol glycoside was soluble for at least 3 days with samples of each of mandelic acid and pyromellitic acid at a 1:1 or a 0.5:1 molar ratio of acid to steviol glycoside.

TABLE 4

| | | Ratio of acid | | | | |
|---|---|---|---|---|---|---|
| | MW of | to steviol | | mM of | % steviol | mM of steviol |
| Acid | acid | glycoside | % acid | acid | glycoside | glycoside |
| Mandelic | 152.15 | 1:1 | 0.035% | 2.35 mM | 0.3% | 2.35 mM |
| acid | g/mol | | | | | |
| Mandelic | 152.15 | 0.5:1 | 0.018% | 1.18 mM | 0.3% | 2.35 mM |
| acid | g/mol | | | | | |
| Pyromellitic | 254.15 | 1:1 | 0.060% | 2.35 mM | 0.3% | 2.35 mM |
| acid | g/mol | | | | | |
| Pyromellitic | 254.15 | 0.5:1 | 0.030% | 1.18 mM | 0.3% | 2.35 mM |
| acid | g/mol | | | | | |

TABLE 5

| Sample | pH | Day 0 | Day | Day 2 | Day 3 |
|---|---|---|---|---|---|
| Mandelic | 3.64 | Clear | Clear | Clear | Clear |
| acid | | 1.18 NTU | 1.52 | 2.56 NTU | 3.21 |
| 1:1 ratio | | | NTU | | NTU |
| Mandelic | 3.86 | Clear | Clear | Clear (some | Clear |
| acid | | 0.857 NTU | 1.16 | floating dust) | 4.05 |
| 0.5:1 ratio | | | NTU | 2.56 NTU | NTU |
| Pyromellitic | 2.99 | Clear | Clear | Clear | Clear |
| acid | | 1.18 NTU | 1.13 | 1.51 NTU | 1.91 |
| 1:1 ratio | | | NTU | | NTU |
| Pyromellitic | 3.21 | Clear | Clear | Clear some | Clear |
| acid | | 1.06 NTU | 0.992 | floating dust, | 3.65 |
| 0.5:1 ratio | | | NTU | could be ppt?) | NTU |
| | | | | 1.85 NTU | |

Ppt = precipitate

### Comparison of Mandelic Acid and Pyromellitic Acid at a 0.25:1 or a 0.1:1 Molar Ratio of Acid to Steviol Glycoside

Samples of each of mandelic acid and pyromellitic acid were prepared with steviol glycoside. Each acid was dissolved in Millipore water and then steviol glycoside (about 95% total steviol glycosides with about 75% Reb M and about 5% Reb D) was added and each sample stirred for approximately 30 mM. Each sample was then heated to 75° C. and allowed to cool to room temperature. Samples were prepared with a final steviol glycoside concentration of 0.3% by weight (2.35 mM) and at a 0.25:1 or a 0.1:1 molar ratio of acid to steviol glycoside as shown in Table 6. A pH of each sample was measured. A turbidity of each sample was measured in NTU (Nephelometric Turbidity Units)(measured with Turbiscan LA10 Expert, Formulaction S.A.). Each sample was observed for solubility. The solubility results for each sample are shown in Table 7. These experiments showed that 0.3% steviol glycoside was soluble for at least several days with samples of each of mandelic acid and pyromellitic acid at a 0.25:1 or a 0.1:1 molar ratio of acid to steviol glycoside. These experiments also showed that 0.3% steviol glycoside was soluble for at least 5 days with samples of pyromellitic acid at a 0.25:1 or a 0.1:1 molar ratio of pyromellitic acid to steviol glycoside.

TABLE 6

| | | Ratio of acid | | | | |
|---|---|---|---|---|---|---|
| | MW of | to steviol | | | % steviol | mM of steviol |
| Sample Acid | acid | glycoside | % acid | mM of acid | glycoside | glycoside |
| Mandelic | 152.15 | 0.25:1 | 0.009% | 0.588 mM | 0.3% | 2.35 mM |
| acid | g/mol | | | | | |
| Mandelic | 152.15 | 0.1:1 | 0.004% | 0.235 mM | 0.3% | 2.35 mM |
| acid | g/mol | | | | | |
| Pyromellitic | 254.15 | 0.25:1 | 0.015% | 0.588 mM | 0.3% | 2.35 mM |
| acid | g/mol | | | | | |
| Pyromellitic | 254.15 | 0.1:1 | 0.006% | 0.235 mM | 0.3% | 2.35 mM |
| acid | g/mol | | | | | |

TABLE 7

| Sample | pH | Day 0 | Day 1 | Day 2 | Day 5 |
|---|---|---|---|---|---|
| Mandelic acid | 3.75 | Clear | Clear | Clear | Slight ppt |
| 0.25:1 ratio | | 0.899 | 1.05 NTU | 1.37 NTU | 3.03 NTU |
| | | NTU | | | |
| Mandelic acid | 3.93 | Clear | Clear | Clear | Ppt |
| 0.1:1 ratio | | 1.29 NTU | 2.57 NTU | 3.88 NTU | 6.53 NTU |
| Pyromellitic | 3.43 | Clear | Clear | Clear | Clear |
| acid | | 1.14 NTU | 1.21 NTU | 2.45 NTU | 5.17 NTU |
| 0.25:1 ratio | | | | | |
| Pyromellitic | 3.64 | Clear | Clear | Clear | Clear |
| acid | | 1.19 NTU | 1.28 NTU | 1.81 NTU | 2.62 NTU |
| 0.1:1 ratio | | | | | |

Ppt = precipitate

### Comparison of Mandelic Acid and Pyromellitic Acid at a 5:1 or a 2:1 Molar Ratio of Acid to Steviol Glycoside for Each of Rebaudoside B, Rebaudoside D, and Rebaudoside M

Samples of each of mandelic acid (Sigma Aldrich, 99%) and pyromellitic acid (Sigma Aldrich, 96%) were prepared with each of Rebaudoside B, Rebaudoside D, and Rebaudoside M to assay for solubility. Stock solutions of mandelic acid and pyromellitic acid were prepared in volumetric flasks. Mandelic acid was prepared at a 5% by weight concentration and pyromellitic acid was prepared at a 0.75% by weight concentration. The Rebaudoside B samples were prepared with a final concentration of 0.06% by weight concentration of Rebaudoside B. The Rebaudoside D samples were prepared with a final concentration of 0.12% by weight concentration of Rebaudoside D. The Rebaudoside M samples were prepared with a final concentration of 0.5% by weight concentration of Rebaudoside M. For each of the Rebaudoside B, Rebaudoside D, and Rebaudoside M samples at each of the 5:1 and 2:1 molar acid to steviol glycoside ratios, the respective acid concentration is shown in Table 8.

TABLE 8

| Molar ratio | Rebaudoside B | Rebaudoside D | Rebaudoside M |
|---|---|---|---|
| (acid:steviol | (at 0.06% final | (at 0.12% final | (at 0.5% final |
| glycoside) | concentration) | concentration) | concentration) |
| 5:1 | 3.727 mM acid | 5.314 mM acid | 19.360 mM acid |
| 2:1 | 1.491 mM acid | 2.125 mM acid | 7.744 mM acid |

Sample solutions of mandelic acid and pyromellitic acid were prepared by adding stock acid solutions and water to a final volume of 40 mL as shown in Table 9 for a 5:1 molar ratio of acid to steviol glycoside and in Table 10 for a 2:1 molar ratio of acid to steviol glycoside.

TABLE 9

| Acid 5:1 molar | | | |
|---|---|---|---|
| ratio of | Rebaudoside B | Rebaudoside D | Rebaudoside M |
| acid to steviol | (at 0.06% final | (at 0.12% final | (at 0.5% final |
| glycoside | concentration) | concentration) | concentration) |
| Mandelic acid | 0.454 mL of acid | 0.647 mL of acid | 2.357 mL of acid |
| Pyromellitic | 5.052 mL of acid | 7.203 mL of acid | 26.242 mL of acid |
| acid | | | |

TABLE 10

| Acid 2:1 molar | | | |
|---|---|---|---|
| ratio of | Rebaudoside B | Rebaudoside D | Rebaudoside M |
| acid to steviol | (at 0.06% final | (at 0.12% final | (at 0.5% final |
| glycoside | concentration) | concentration) | concentration) |
| Mandelic acid | 0.181 mL of acid | 0.259 mL of acid | 0.943 mL of acid |
| Pyromellitic | 2.021 mL of acid | 2.881 mL of acid | 10.497 mL of acid |
| acid | | | |

After the sample acid solutions were prepared, the respective steviol glycosides (Rebaudoside B, Rebaudoside D, and Rebaudoside M) were added as solid powder to the corresponding sample acid solutions at the corresponding steviol glycoside concentrations (0.06% by weight concentration of Rebaudoside B, 0.12% by weight concentration of Rebaudoside D, 0.5% by weight concentration of Rebaudoside M). The sample solutions with the respective steviol glycoside were stirred for 1 h, heated to 75° C., and promptly removed to cool to room temperature. A pH of each sample acid solution with steviol glycoside was measured. A turbidity of each sample acid solution with steviol glycoside was measured in NTU (Nephelometric Turbidity Units) (measured with Turbiscan LA10 Expert, Formulaction S.A.). Each sample acid solution with steviol glycoside was observed for solubility. The solubility results for each sample acid solution with steviol glycoside are shown in Table 11. These experiments showed that some samples of each of mandelic acid, pyromellitic acid, and quinic acid and individual steviol glycosides (Rebaudoside B, Rebaudoside D, and Rebaudoside M) were soluble for one or more days with samples of each of mandelic acid and pyromellitic acid at a 5:1 or a 2:1 molar ratio of acid to steviol glycoside.

TABLE 11

| Sample | pH | Day 0 | Day 1 | Day 4 |
|---|---|---|---|---|
| Mandelic acid:Reb B | 3.56 | Ppt upon | Heavy ppt | Heavy ppt |
| 5:1 molar ratio acid | | cooling | 814 NTU | 1045 NTU |
| 0.06% Reb B | | 46.2 NTU | | |
| Mandelic:Reb B | 3.78 | Slight ppt upon | Heavy ppt | Heavy ppt |
| 2:1 molar ratio acid | | cooling | 821 NTU | 983 NTU |
| 0.06% Reb B | | 11.5 NTU | | |
| Mandelic:Reb D | 3.45 | Clear | Slight ppt | Ppt |
| 5:1 molar ratio acid | | 1.38 NTU | 1.31 NTU | 1.45 NTU |
| 0.12% Reb D | | | | |
| Mandelic:Reb D | 3.7 | Clear | Clear | Slight ppt |
| 2:1 molar ratio acid | | 0.463 NTU | 0.982 | 1.99 NTU |
| 0.12% Reb D | | | | |
| Mandelic:Reb M | 3.15 | Clear | Ppt | Ppt |
| 5:1 molar ratio acid | | 1.54 NTU | 6.48 | 154 NTU |
| 0.5% Reb M | | | | |
| Mandelic:Reb M | 3.53 | Clear | Ppt | Ppt |
| 2:1 molar ratio acid | | 1.29 NTU | 3.42 NTU | 60.4 NTU |
| 0.5% Reb M | | | | |
| Pyromellitic:Reb B | 2.77 | Very slight ppt | Heavy ppt | Heavy ppt |
| 5:1 molar ratio acid | | 0.627 NTU | 917 NTU | 1011 NTU |
| 0.06% Reb B | | | | |
| Pyromellitic:Reb B | 3.07 | Very slight | Heavy ppt | Heavy ppt |
| 2:1 molar ratio acid | | ppt/particles | 778 NTU | 817 NTU |
| 0.06% Reb B | | 0.607 NTU | | |
| Pyromellitic:Reb D | 2.73 | Clear | Clear | Clear |
| 5:1 molar ratio acid | | 0.732 NTU | 1.51 NTU | 2.15 NTU |
| 0.12% Reb D | | | | |
| Pyromellitic:Reb D | 3.00 | Clear | Clear | Clear |
| 2:1 molar ratio acid | | 0.425 NTU | 0.619 NTU | 0.972 NTU |
| 0.12% Reb D | | | | |
| Pyromellitic:Reb M | 2.31 | Clear | Ppt | Ppt |
| 5:1 molar ratio acid | | 0.694 NTU | 13.0 NTU | 84.3 NTU |
| 0.5% Reb M | | | | |
| Pyromellitic:Reb M | 2.55 | Clear | Very slight | Ppt |
| 2:1 molar ratio acid | | 0.845 NTU | ppt | 261 NTU |
| 0.5% Reb M | | | 3.63 NTU | |

Ppt = precipitate

### Comparison of Gallic Acid at a 5:1 or a 2:1 Molar Ratio of Gallic Acid to Steviol Glycoside for Each of Rebaudoside B, Rebaudoside D, and Rebaudoside M

Samples of gallic acid were prepared with each of Rebaudoside B, Rebaudoside D, and Rebaudoside M to assay for solubility. A stock solution of gallic acid (Sigma Aldrich, 97.5%) was prepared in volumetric flasks at a 0.5% by weight concentration. The Rebaudoside B samples were prepared with a final concentration of 0.06% by weight concentration of Rebaudoside B. The Rebaudoside D samples were prepared with a final concentration of 0.12% by weight concentration of Rebaudoside D. The Rebaudoside M samples were prepared with a final concentration of 0.5% by weight concentration of Rebaudoside M. For each of the Rebaudoside B, Rebaudoside D, and Rebaudoside M samples at each of the 5:1 and 2:1 molar acid to steviol glycoside ratios, the respective gallic acid concentrations are shown in Table 12.

TABLE 12

| Molar ratio | Rebaudoside B | Rebaudoside D | Rebaudoside M |
|---|---|---|---|
| (gallic acid:steviol | (at 0.06% final | (at 0.12% final | (at 0.5% final |
| glycoside) | concentration) | concentration) | concentration) |
| 5:1 | 5.073 mM | 7.232 mM | 26.349 mM gallic |
| | gallic acid | gallic acid | acid |
| 2:1 | 2.029 mM | 2.893 mM | 10.540 mM gallic |
| | gallic acid | gallic acid | acid |

Sample solutions of gallic acid were prepared by adding the stock gallic acid solutions and water to a final volume of 40 mL for 5:1 molar ratios of gallic acid to steviol glycoside and for 2:1 molar ratios of gallic acid to individual steviol glycosides (Rebaudoside B, Rebaudoside D, and Rebaudoside M). After the sample gallic acid solutions were prepared, the respective steviol glycosides (Rebaudoside B, Rebaudoside D, and Rebaudoside M) were added as solid powder to the corresponding sample gallic acid solutions at the corresponding steviol glycoside concentrations (0.06% by weight concentration of Rebaudoside B, 0.12% by weight concentration of Rebaudoside D, 0.5% by weight concentration of Rebaudoside M). The sample solutions with the respective steviol glycoside were stirred for 1 hour, heated to 75° C., and promptly removed to cool to room temperature. A pH of each sample gallic acid solution with steviol glycoside was measured. A turbidity of each sample gallic acid solution with steviol glycoside was measured in NTU (Nephelometric Turbidity Units)(measured with Turbiscan LA10 Expert, Formulaction S.A.). Each sample gallic acid solution with steviol glycoside was observed for solubility. The solubility results for each sample gallic acid solution with steviol glycoside are shown in Table 13. These experiments showed that some samples of gallic acid and individual steviol glycosides (Rebaudoside B, Rebaudoside D, and Rebaudoside M) were soluble for one or more days with gallic acid at a 5:1 or a 2:1 molar ratio of gallic acid to steviol glycoside. These experiments also showed that some samples of gallic acid and Rebaudoside D were soluble for 3 or more days with gallic acid at a 5:1 or a 2:1 molar ratio of gallic acid to steviol glycoside.

TABLE 13

| Sample | pH | Day 0 | Day 1 | Day 2 | Day 3 |
|---|---|---|---|---|---|
| Gallic acid:Reb B | 3.74 | Ppt (fine dust), | Heavy ppt, | Heavy ppt, | Heavy ppt, |
| 5:1 molar ratio acid | | 1.37 NTU | 574 NTU | 820 NTU | 752 NTU |
| 0.06% Reb B | | | | | |
| Gallic acid:Reb B | 4.07 | Ppt (fine dust), | Heavy ppt, | Heavy ppt, | Heavy ppt, |
| 2:1 molar ratio acid | | 1.54 NTU | 675 NTU | 863 NTU | 984 NTU |
| 0.06% Reb B | | | | | |
| Gallic acid:Reb D | 3.78 | Clear (with a | Clear, 0.545 | Clear, 0.526 | Clear, |
| 5:1 molar ratio acid | | few floaties), | NTU | NTU | 0.654 |
| 0.12% Reb D | | 0.584 NTU | | | NTU |
| Gallic acid:Reb D | 4.00 | Clear (with a | Clear, 0.681 | Clear, 0.824 | Very slight |
| 2:1 molar ratio acid | | few floaties), | NTU | NTU | ppt, 1.18 |
| 0.12% Reb D | | 0.500 NTU | | | NTU |
| Gallic acid:Reb M | 3.55 | Clear, 1.04 | Clear, 1.13 | Very slight | Ppt, 5.31 |
| 5:1 molar ratio acid | | NTU | NTU | ppt, 2.34 | NTU |
| 0.5% Reb M | | | | NTU | |
| Gallic acid:Reb M | 3.85 | Clear, 2.79 | Ppt, 14.0 | Ppt, 30.0 | Ppt, 107 |
| 2:1 molar ratio acid | | NTU | NTU | NTU | NTU |
| 0.5% Reb M | | | | | |

Comparison of Gallic Acid at Various Molar Ratios of Gallic Acid to Steviol Glycoside for a Solution of Steviol Glycoside s (about 95% Total Steviol Glycosides with about 75% Reb M and about 5% Reb D)

Samples of gallic acid (Sigma Aldrich, 97.5%) were prepared with steviol glycoside (about 95% total steviol glycosides with about 75% Reb M and about 5% Reb D) to assay for solubility. A stock solution of gallic acid was prepared by volumetric flask at a 0.5% by weight concentration. The steviol glycoside samples were prepared with a final concentration of 0.3% or 0.6% by weight concentrations of a combination of steviol glycoside at molar ratios of 0.5:1 to 7:1 gallic acid to steviol glycoside ratios, the respective gallic acid concentrations are shown in Table 14.

TABLE 14

| Molar ratio | Steviol glycosides | Steviol glycosides |
|---|---|---|
| (gallic acid:steviol | (at 0.3% final | (at 0.6% final |
| glycoside) | concentration) | concentration) |
| 7:1 | — | 0.56% gallic acid |
| 5:1 | 0.20% gallic acid | 0.40% gallic acid |
| 2:1 | 0.08% gallic acid | 0.16% gallic acid |
| 1:1 | 0.04% gallic acid | 0.08% gallic acid |
| 0.5:1 | 0.02% gallic acid | 0.04% gallic acid |

Sample solutions of gallic acid were prepared by adding the stock gallic acid solutions and water to a final volume of 40 mL for 7:1, 5:1, 2:1, 1:1, and 0.5:1 molar ratios of gallic acid to steviol glycoside. After the sample gallic acid solutions were prepared, the steviol glycoside was added as solid powder to the corresponding sample gallic acid solutions at 0.3% or 0.6% by weight concentrations of steviol glycoside. The sample solutions were stirred for 1 hour, heated to 75° C., and promptly removed to cool to room temperature. A pH of each sample gallic acid solution with steviol glycoside was measured. A turbidity of each sample gallic acid solution with steviol glycoside was measured in NTU (Nephelometric Turbidity Units)(measured with Turbiscan LA10 Expert, Formulaction S.A.). Each sample gallic acid solution with steviol glycoside was observed for solubility. The solubility results for each sample gallic acid solution with steviol glycoside are shown in Tables 15 and 16.

These experiments showed that samples of gallic acid and steviol glycosides were soluble for 3 or more days with 5:1 or 2:1 molar ratios of gallic acid to steviol glycoside and at 0.3% by weight total concentration of steviol glycoside. These experiments also showed that samples of gallic acid and steviol glycosides were soluble for 3 or more days with 1:1 or 0.5:1 molar ratios of gallic acid to steviol glycoside and at 0.3% by weight total concentration of steviol glycoside. These experiments also showed that samples of gallic acid and steviol glycosides were soluble for 5 or more days with a 7:1 molar ratio of gallic acid to steviol glycoside at a 0.6% by weight total concentration of steviol glycoside. It was also noted that gallic acid imparted a brownish tinge to the sample solutions that was more apparent at higher concentrations. This brownish tinge was observed after about 3 days.

TABLE 15

| Sample | pH | Day 0 | Day 1 | Day 2 | Day 3 |
|---|---|---|---|---|---|
| Gallic acid:SG | 3.53 | Clear | Clear | Clear | Clear |
| 5:1 molar ratio | | 1.16 NTU | 1.24 NTU | 1.26 NTU | 1.56 NTU |
| acid 0.3% SG | | | | | |
| Gallic acid:SG | 3.88 | Clear | Clear | Clear | Very slight |
| 2:1 molar ratio | | 0.796 NTU | 1.19 NTU | 1.49 NTU | ppt |
| acid 0.3% SG | | | | | 3.38 NTU |
| Gallic acid:SG | 3.61 | Clear | Very slight | Clear | Ppt |
| 5:1 molar ratio | | 2.85 NTU | ppt | 3.50 NTU | 6.36 NTU |
| acid 0.6% SG | | | 3.46 NTU | | |
| Gallic acid:SG | 3.83 | Clear | Slight ppt | Slight ppt | Ppt |
| 2:1 molar ratio | | 2.37 NTU | 3.07 NTU | 6.00 NTU | 58.9 NTU |
| acid 0.6% SG | | | | | |

SG = steviol glycoside
Ppt = precipitate

TABLE 16

| Sample | Day 0 | Day 3 | Day 4 | Day 5 |
|---|---|---|---|---|
| Gallic acid:SG | Clear | Clear | Clear | Clear |
| 1:1 molar ratio acid | 0.846 NTU | | | 0.882 |
| 0.3% SG | | | | NTU |
| Gallic acid:SG | Clear | Clear | Clear | Clear |
| 0.5:1 molar ratio acid | 1.16 NTU | | | 1.28 NTU |
| 0.3% SG | | | | |
| Gallic acid:SG | Clear | Clear | Clear | Clear |
| 7:1 molar ratio acid | 2.33 NTU | | | 1.60 NTU |
| 0.6% SG | | | | |

SG = steviol glycoside
Ppt = precipitate

Comparison of Solubilities of Samples Comprising Mandelic Acid, Pyromellitic Acid, and Gallic Acid and Steviol Glycoside (about 95% Total Steviol Glycosides with about 75% Reb M and about 5% Reb D) in Citrate Buffer

Samples of mandelic acid, pyromellitic acid, and gallic acid were prepared with steviol glycoside (about 95% total steviol glycosides with about 75% Reb M and about 5% Reb D) to assay for solubility. The samples were prepared in a citrate buffer (50 mM, pH 3, with 0.009% sodium benzoate) and comprised either 0.3% steviol glycoside, 0.6% steviol glycoside, 0.06% Rebaudoside B, 0.12% Rebaudoside D, and 0.5% Rebaudoside M and either mandelic acid, pyromellitic acid, gallic acid, or no acid. The sample solutions were stirred for 1 h, heated to 75° C., and promptly removed to cool to room temperature. A turbidity of each sample solution with steviol glycoside was measured in NTU (Nephelometric Turbidity Units)(measured with Turbiscan LA10 Expert, Formulaction S.A.). Each sample solution with steviol glycoside was observed for solubility. The solubility results for each sample solution with steviol glycoside is shown in Table 17.

TABLE 17

| Sample | Day 0 | Day 1 | Day 2 | Day 3 |
|---|---|---|---|---|
| 0.3% SG and | Clear | Clear | Clear | Very |
| No acid | | | | slight ppt |
| 0.3% SG and | Clear | Clear | Clear | Ppt |
| mandelic acid | | | | |
| 0.3% SG and | Clear | Clear | Clear | Very |
| pyromellitic acid | | | | slight ppt |
| 0.3% SG and | Clear | Clear | Very slight | Ppt |
| gallic acid | | | ppt | |
| 0.6% SG and | Clear | Clear | Ppt | Ppt |
| No acid | | | | |
| 0.6% SG and | Clear | Ppt | Ppt | Ppt |
| Mandelic acid | | | | |
| 0.6% SG and | Clear | Very slight | Ppt | Ppt |
| Pyromellitic acid | | ppt | | |
| 0.6% SG and | Clear | Ppt | Ppt | Ppt |
| gallic acid | | | | |
| 0.06% Reb B and | Ppt | Ppt | Ppt | Ppt |
| no acid | | | | |
| 0.06% Reb B and | Ppt | Ppt | Ppt | Ppt |
| Mandelic acid | | | | |
| 0.06% Reb B and | Ppt | Ppt | Ppt | Ppt |
| Pyromellitic acid | | | | |
| 0.06% Reb B and | Ppt | Ppt | Ppt | Ppt |
| Gallic acid | | | | |
| 0.12% Reb D and | Clear | Clear | Ppt | Ppt |
| no acid | | | | |
| 0.12% Reb D and | Clear | Clear | Very slight | Ppt |
| Mandelic acid | | | ppt | |
| 0.12% Reb D and | Clear | Clear | Very slight | ppt |
| Pyromellitic acid | | | Ppt | |
| 0.12% Reb D and | Clear | Clear | Ppt | Ppt |
| Gallic acid | | | | |
| 0.5% Reb M and | Clear | Clear | Ppt | Ppt |
| no acid | | | | |
| 0.5% Reb M and | Clear | Ppt | Ppt | Ppt |
| Mandelic acid | | | | |
| 0.5% Reb M and | Clear | Clear | Ppt | Ppt |
| Pyromellitic acid | | | | |
| 0.5% Reb M and | Clear | Clear | Ppt | Ppt |
| Gallic acid | | | | |
| 0.3% SG | Cloudy | Cloudy | — | — |
| No Acid | | | | |
| No Heating | | | | |
| Stirred Overnight | | | | |
| 0.3% SG and | Cloudy | Cloudy | — | — |
| Mandelic acid | | | | |
| No Heating | | | | |
| Stirred Overnight | | | | |
| 0.3% SG and | Cloudy | Cloudy | — | — |
| Pyromellitic acid | | | | |
| No Heating | | | | |
| Stirred Overnight | | | | |
| 0.3% SG and | Cloudy | Cloudy | — | — |
| Gallic acid | | | | |
| No Heating | | | | |
| Stirred Overnight | | | | |

SG = steviol glycoside
Ppt = precipitate

1. An aqueous steviol glycoside solution comprising:
greater than 0.2% (wt) of a total steviol glycoside composition comprising one or more steviol glycosides, wherein if the steviol glycoside composition includes rebaudioside A, rebaudioside D, or rebaudioside M, the rebaudioside A individual concentration is at least 1% (wt), the rebaudioside D individual concentration is at least 0.2% (wt), or the rebaudioside M individual concentration is at least 0.3% (wt); and
a solubility enhancer in an amount effective to enhance the solubility of at least one of the steviol glycosides.

2. The aqueous steviol glycoside solution of claim 1, wherein the solubility enhancer comprises gallic acid, mandelic acid or pyromellitic acid.

3. The aqueous steviol glycoside solution of claim 1, wherein the amount of solubility enhancer effective to enhance solubility comprises an amount such that the total steviol glycoside remains in solution for at least three days when stored at a temperature of about 20° C. to about 30° C., or about 23° C. to about 28° C.

4. The aqueous steviol glycoside solution of claim 1, wherein the solubility enhancer is present at a molar ratio of solubility enhancer compound to steviol glycoside of between 1:0.5 to 1:7.

5. The aqueous steviol glycoside solution of claim 1, wherein the total steviol glycoside composition comprises rebaudioside A.

6. The aqueous steviol glycoside solution of claim 1, wherein the total steviol glycoside composition comprises rebaudioside D.

7. The aqueous steviol glycoside solution of claim 1, wherein the total steviol glycoside composition comprises rebaudioside M.

8. The aqueous steviol glycoside solution of claim 1, further comprising corn starch fiber or gellan gum.

9-11. (canceled)

12. The aqueous steviol glycoside solution of claim 1, wherein the individual rebaudioside M concentration is 3000 ppm to 6000 ppm.

13. The aqueous steviol glycoside solution of claim 1 having greater than 0.3% (wt) total steviol glycosides.

14. The aqueous steviol glycoside solution of claim 1 comprising less than 50% (wt), 40% (wt), 30% (wt), 20% (wt), 10% (wt), or 5% (wt) of a C1-C4 alcohol.

15. The aqueous steviol glycoside solution of claim 14, which is free of the C1-C4 alcohol.

16. (canceled)

17. A beverage composition comprising the aqueous steviol glycoside solution of claim 1 which aqueous steviol glycoside solution further comprises one or more of phosphoric acid, citric acid, sodium citrate, and carbonated water.

18. A sweetener comprising:
a steviol glycoside composition comprising one or more steviol glycosides; and
a solubility enhancer in an amount effective to enhance the solubility of at least one of the steviol glycosides,
wherein the sweetener is soluble in water without alcohol at a temperature of about 20° C. to about 30° C. at a total steviol glycoside concentration of greater than 0.2% (wt).

19. The sweetener of claim 18, wherein the solubility enhancer comprises gallic acid, mandelic acid or pyromellitic acid.

20. The sweetener of claim 18, wherein the solubility enhancer compound is present at a molar ratio of solubility enhancer to steviol glycoside of between 0.5:1 to 7:1.

21. The sweetener of claim 18, wherein the total steviol glycoside composition comprises rebaudioside A.

22. The sweetener of claim 18, wherein the total steviol glycoside composition comprises rebaudioside D.

23. The sweetener of claim 18, wherein the total steviol glycoside composition comprises rebaudioside M.

24. The sweetener of claim 18, further comprising corn starch fiber or gellan gum.

25. (canceled)

26. A method for solubilizing a total steviol glycoside composition, the method comprising:
contacting a steviol glycoside and a solubility enhancer to prepare the steviol glycoside solution of claim 1.

27. (canceled)
